(19) United States
(12) Patent Application Publication
(10) Pub. No.: US 2022/0089259 A1
(43) Pub. Date: Mar. 24, 2022

(54) METHOD AND APPARATUS FOR WATER SPORTS AUTOMATION AND ENHANCED SITUATIONAL AWARENESS

(71) Applicants: Danielle T. Williams, Bellevue, WA (US); Timothy M. Mitchell, Seattle, WA (US)

(72) Inventors: Danielle T. Williams, Bellevue, WA (US); Timothy M. Mitchell, Seattle, WA (US)

(21) Appl. No.: 17/481,309

(22) Filed: Sep. 22, 2021

Related U.S. Application Data
(60) Provisional application No. 63/081,489, filed on Sep. 22, 2020.
(60) Provisional application No. 63/218,030, filed on Jul. 2, 2021.

(51) Int. Cl. B63C 9/00; G05D 1/00; B63H 21/21

(52) U.S. Cl. CPC B63C 9/0005; B63C 2009/0017; B63H 21/21; G05D 1/0055

(57) ABSTRACT

An objective of the present invention is to provide a system to sense immersion of a participant into water. The system comprises a smart flag and an alarm device of a watercraft, and an FOB device of a participant. The smart flag, the alarm, and the FOB device are wirelessly connected to each other. The FOB device detects the immersion of the participant in the water. The smart flag is automatically deployed based on the detected immersion. The alarm device is automatically turned ON creating an alarm indicating an SOS signal. When the participant gets submerged in the water, the communication is ceased, thus initiating the flag to go up automatically and alarm a captain of the watercraft. Deployment of the flag lets surrounding watercraft to know that the participant is in the water.

### CROSS-REFERENCE TO RELATED PATENT DOCUMENTS

This patent application claims the benefit of priority of U.S. Provisional Application No. 63/081,489, entitled “METHOD AND APPARATUS FOR AUTOMATING AND ENHANCING SITUATIONAL AWARENESS FOR ENABLING SAFE TOWABLE RECREATION,” filed Sep. 22, 2020, and U.S. Provisional Application No. 63/218,030, entitled “METHOD AND APPARATUS FOR WATER SPORTS AUTOMATION AND ENHANCED SITUATIONAL AWARENESS,” filed Jul. 2, 2021, which are hereby incorporated herein by reference in its entirety.

### FIELD OF THE INVENTION

The present invention relates generally to water sports and, more particularly, to a method and an apparatus for automating and enhancing situational awareness for enabling safe towable recreation. The implementation of the disclosed method and apparatus automates several manual elements currently required during the towable recreation and enables safe vessel (tow watercraft) recreation. It also improves the safety of participants and property in the area of the tow watercraft recreational operation. When a participant gets submerged in the water, the communication is ceased, thus initiating a flag to go up automatically and alarm a captain of the watercraft. Deployment of the flag lets surrounding watercraft to know that the participant is in the water.

### BACKGROUND

People participate in a wide variety of watersports, with more seemingly being created all the time. Such sports include surfing, stand up paddling, rafting, kayaking, wake boarding, water skiing, tow watercraft recreation, snorkeling, kite boarding, canoeing, parasailing, diving, or the like. Among all these water activities, towboat recreation has become a more popular activity both at the participant, athletic, and tournament levels. As is well known, the outboard or inboard motors of tow watercrafts produce a wake which extends rearwardly from the stern of the tow watercrafts for a number of feet. The participant grasps a tow rope attached to a pylon mounted to the tow watercraft and/or Bimini of the tow watercraft, typically maneuver in a side-to-side direction, back and forth across the wake, during a towing run. The extent of side-to-side movement of the participant can vary significantly depending on the length of the tow rope, the skill of the participant, the type of activities being performed during a tow run, and the like. However, during the towable recreation, safety of the participants has been always a big concern. Due to lack of efficient and effective safety measures while practicing towing recreation, accidents are on the rise. Currently, the safety management of the participant is done manually. Also, while recreating, it is not uncommon for a tow watercraft driver and/or a person monitoring the participant to become fatigued, board, or distracted. This may lead to accidents and inefficiencies in boating operations. In light of the foregoing, there exists a need for a technical and reliable solution that solves the above-mentioned problems and automates these manual functions and make them more reliable, effective, and safe.

### SUMMARY

It will be understood that this disclosure is not limited to the apparatus described herein, as there can be multiple possible embodiments of the present disclosure which are not expressly illustrated in the present disclosure. It is also to be understood that the terminology used in the description is for the purpose of describing the versions or embodiments only and is not intended to limit the scope of the present disclosure.

When a participant wants to be towed, it generally requires two other people to facilitate the activity. A first person may operate a tow watercraft by controlling both speed and direction. The watercraft may correspond to at least one of but not limited to a stand-up paddle board, rowboat, canoe, river raft, jet ski, jet boat, hydrofoil, or inner tube. Also, the first person is responsible for detecting and avoiding potential collisions and myriad of other dangers in and around the tow watercraft in the water. A second person is generally required to manage the logistics of towing the person behind the tow watercraft. The present invention, disclosed herein, provides a central controller or actuator to reduce the manual effort required to support tow watercraft recreation, while improving situational awareness to all the stakeholders, thereby, improving safety, increasing fun, and reducing maintenance and operating cost. As the components of the tow watercraft recreational equipment become connected to the Internet, big data analytics may be incorporated to identify trends that can be leverage for further product optimization. Prior to the identification of the trends, the relevant data is acquired from one or more controllers of one or more tow watercrafts, and then the relevant data is processed to determine useful and real-time trends associated with the tow watercraft recreational activities that are happening in and around. Further, at least one of the acquired data and the one or more trends may be discernment to one or more other tow watercrafts, participants, or equipment. These data and trends may be rendered via one or more application portals (i.e., software applications) running on one or more respective devices such as user devices or tow watercraft devices. In addition to this, the present invention also discloses capturing, transferring, and using user data. The main purposes include data collection and mining, machine learning, social sharing, or the like.

Another objective of the present invention is to manage the rope operation during the tow watercraft recreation. In an embodiment, both the launching and retrieval of a tow rope that is tethered to the tow watercraft and projected to a participant may be managed to facilitate towing behind the tow watercraft. In an embodiment, the participant may hold on to the tow rope to be towed at speeds which allow the participant to glide on top of the water and recreate. The disclosed invention facilitates monitoring of all the personnel (such as the participant, driver, observer, swimmers, passengers, and others) engaged in being towed operation. The disclosed invention further facilitates automatic generation of signals when the participant is down. The disclosed invention further facilitates to create a network of multiple tow watercrafts on the lake to provide an extended level of system operation, control, and optimization. For example, the acquired data and the generated trends may be discernment to the one or more tow watercrafts on the lake for facilitating ease of operation and control, along with the extended optimization.

Another objective of the present invention is to provide an apparatus for RTB (recreational tow watercraft) automation and enhanced situational awareness. The apparatus is configured to facilitate:
Launch Attachment and Retrieval—Automatically gets the tow rope from the tow watercraft to the participant. In an embodiment, the rope projection and retrieval may be realized pneumatically or with a spring energy storage mechanism. The material could have a significant impact on manufacturing, cost, and reliability.
Monitor and Control—Detect the personnel (such as the participant, driver, observer, swimmers, passengers, and others) engaged in the recreation operation in and around the tow watercraft. Monitoring may be facilitated with several methods of location technology. These include, but are not limited to, Sonar, Radar, Lidar, GPS, Differential GPS, or any combination thereof.
Detect, Avoid, and Signal—Using Sonar, Radar, Lidar, Visual, and GPS data, the apparatus is configured to determine or track location of all stakeholders associated with the tow watercraft and/or other watercrafts in and around the tow watercraft and manage movements to safely operate the recreational activities or other water sport activities. The aim is to find the participant and avoid everything else. In case of any accidental events or mishap, the operator (such as the driver of the tow watercraft) notifies or signals that the participant is down. Such notifications or signals may be communicated to rescue personnel or other watercrafts in its vicinity. Signaling may be achieved with multiple modalities. These include, but are not limited to, auditory, visual, mechanical, or any combination thereof.
Big Data—Collection and processing of Sonar data, Radar data, Lidar data, Visual data, and Position data to track movements in and around the tow watercraft and participant and automatically generate signals when the participant is down
Analytics—Big data is processed and analyzed to optimize system performance
Networking and Engagement—Create a network of multiple tow watercrafts during recreation activities to provide an extended level of system operation, control, and optimization. For example, the acquired data and the generated trends may be discernment to the one or more tow watercrafts on the lake for facilitating ease of operation and control, along with the extended optimization. These data and trends may be rendered via one or more application portals (i.e., software applications) running on one or more respective devices such as user devices or tow watercraft devices. In addition to this, the present invention also discloses capturing, transferring, and using user data. The main purposes include data collection and mining, machine learning, social sharing, or the like.

The apparatus may be configured to integrate these primary functions using various components such as a controller (for facilitating one or more outputs), one or more sensors (for sensing and collecting input data), a memory (for data acquisition and discernment to one or more vessels, participants, and equipment), engagement (via one or more application portals), and networking (for establishing connectivity of one vessel (for example, tow watercraft) to other like vessels (for example, other tow watercrafts in its vicinity). Each part of the present invention complements the overall performance and safety of the total tow watercraft recreation system. This concept may be a full system or a sub-system implementation that could fully or partially enhance the operation and safety of the tow watercraft recreation or blend into a top-level system provided by another party.

Another objective includes to provide a system to sense immersion of a participant into water. The system comprises a smart flag and an alarm device of a watercraft, and an FOB device of a participant. The smart flag, the alarm, and the FOB device are wirelessly connected to each other. The FOB device detects the immersion of the participant in the water. The smart flag is automatically deployed based on the detected immersion. The alarm device is automatically turned ON creating an alarm indicating an SOS signal. When the participant gets submerged in the water, the communication is ceased, thus initiating the flag to go up automatically and alarm a captain of the watercraft. Deployment of the flag lets surrounding watercraft to know that the participant is in the water. The watercraft may include a kill engine or switch that is ignited to turn OFF an ignition system of the watercraft. In case of any emergency, the operator may turn ON or ignite the kill engine or switch. This causes the engine and motion of the craft to stop, presumably enabling the overboard person to swim back to the watercraft.

These and other features and advantages of the present invention will become apparent from the detailed description below, in light of the accompanying drawings.

### BRIEF DESCRIPTION OF ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 is a diagram that illustrates a rear view of a recreational tow watercraft (RTB), according to an exemplary embodiment of the present invention.

FIG. 2 is a diagram that illustrates a schematic rear view of the RTB, according to an exemplary embodiment of the present invention.

FIG. 3 is a diagram that illustrates a prospective view of an exemplary cockpit of the RTB, according to an exemplary embodiment of the present invention.

FIG. 4 is a diagram that illustrates an exemplary data and visualization center of the RTB, according to an exemplary embodiment of the present invention.

FIG. 5A is a diagram that illustrates an exemplary retractable tow rope of the RTB, according to an exemplary embodiment of the present invention.

FIG. 5B is a diagram that illustrates an exemplary RTB controlling device attached to a Bimini of the RTB, according to an exemplary embodiment of the present invention.

FIG. 6 is a diagram that illustrates a top view of the RTB pulling a participant, according to an exemplary embodiment of the present invention.

FIG. 7 is a diagram that illustrates a high-level RTB controlling device, according to an exemplary embodiment of the present invention.

FIGS. 8 and 9 are diagrams that illustrate the RTB controlling device integrated with the RTB, according to an exemplary embodiment of the present invention.

FIG. 10 is a diagram that illustrates a network engagement of the RTB controlling device with one or more remote devices or servers, according to an exemplary embodiment of the present invention.

FIG. 11 is a diagram that illustrates an automatic safety flag on the RTB, according to an exemplary embodiment of the present invention.

FIG. 12 is a diagram that illustrates a captain's alarm on the RTB, according to an exemplary embodiment of the present invention.

FIG. 13 is a diagram that illustrates an FOB device for a participant, according to an exemplary embodiment of the present invention.

FIG. 14 is a diagram that illustrates wireless tethering of FOBs of swimmers and captain, according to an exemplary embodiment of the present invention.

Further areas of applicability of the present invention will become apparent from the detailed description provided hereinafter. It should be further understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes an apparatus for water sports automation and enhanced situational awareness. The implementation of the disclosed apparatus automates several manual elements currently required for a participant to be towed for recreation. It also improves the safety of operators, participants, guests, boaters, swimmers, and other people and property in the area of the tow watercraft recreational (TBR) operation. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein. However, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the present invention.

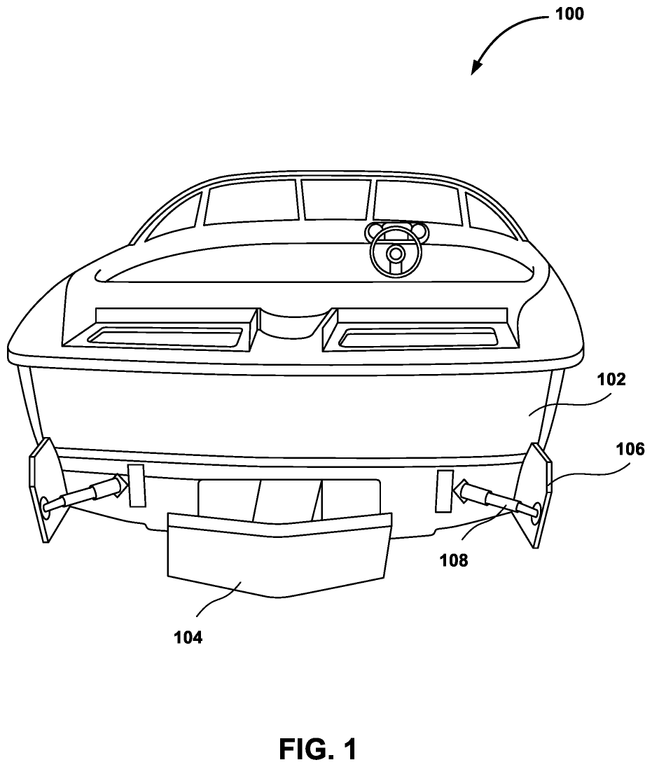

The present invention will now be described with reference to the accompanying drawings, which should be regarded as merely illustrative without restricting the scope and ambit of the present invention. Embodiments of the present invention will now be described with reference to FIGS. 1-14.

FIG. 1 is a diagram that illustrates a rear view of a recreational tow watercraft (RTB) 100, according to an exemplary embodiment of the present invention. A person having ordinary skills in the art would understand that a watercraft, in the present disclosure, may correspond to a stand-up paddle board, rowboat, canoe, river raft, jet ski, jet boat, hydrofoil, or inner tube but should not be construed as limiting to the scope of the present disclosure.

In an embodiment, the RTB 100 may be equipped with a surf or ski or recreational wake system for modifying a wake formed by the RTB 100 while travelling or towing through water. Advantageously, the wake system may enhance surf or ski or recreational wakes with or without supplemental ballast and thus it is possible to enhance wake with less watercraft lean. The wake system may include one or more water diverters such as a water diverter 106. Each water diverter may be adjustably mounted relative to the RTB 100 for deflecting water travelling past a transom 102 of the RTB 100. Broadly, the water diverters are movably mounted with respect to the transom 102. Although the illustrated embodiment shows the flaps mounted directly on the transom 102, one will appreciate that the flaps may be moveably mounted directly or indirectly to the transom 102. For example, the flaps and associated hardware may be mounted on a removable swim platform or other structure that is mounted on or adjacent to the transom 102. As also shown in FIG. 1, the RTB 100 may be equipped with a wake-modifying device 104 to enhance the overall size of the wake formed by the RTB 100. A person having ordinary skills in the art would understand that while various other wake modifying devices may be very beneficial in enhancing the size and shape of a wake, such other wake modifying devices need not be used, nor is essential to be used, in combination with the wake system. Similarly, one will appreciate that positioning extra weight or ballast adjacent to the transom 102 may also be very beneficial in enhancing the size of a wake, with or without the use of a wake modifying device, however, such weight or ballast need not be used, nor is essential to be used, in combination with the wake system. The wake system also includes one or more actuators 108. Each actuator 108 may be secured on the RTB 100 and operably connected to a respective flap 106. In the illustrated embodiment, the actuators 108 are linear actuators including one or more electric motors. However, a person having ordinary skills in the art would understand that other suitable actuators may be employed to move the flaps, including hydraulic and pneumatic motors. Preferably, the actuators 108 are watertight or water resistant, and more preferably waterproof. The actuators 108 are configured to pivot the flaps about their respective pivot axis and position the flaps in different positions. One will also appreciate that manual actuators may also be utilized to secure the flaps in a desired position.

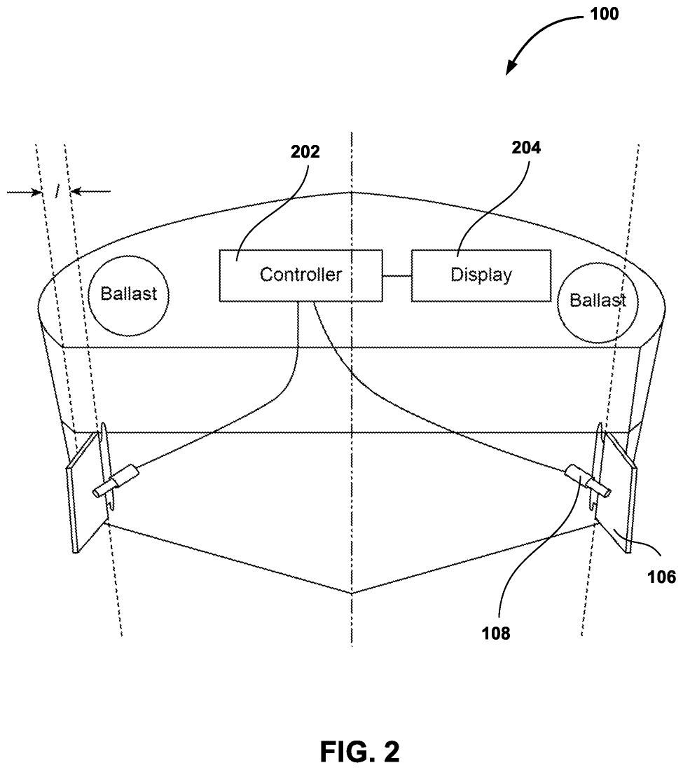

FIG. 2 is a diagram that illustrates a schematic rear view of the RTB 100, according to an exemplary embodiment of the present invention. The RTB 100 may include a controller 202 and a display 204. The controller may include suitable logic, circuitry, interfaces, and/or code, which is executed by the circuitry, to perform one or more designated operations. The controller 202 may be operationally connected to the actuators 108 and may be configured to control the operation of the actuators 108 that selectively control the positions of the respective flap 106. The display 204 is operably connected to or integrated with the controller 202. In the illustrated embodiment, the input device is a discrete touch screen, however, one will appreciate that the display 204 may operate as an input device and may be integrated into a single device, for example, a single screen that is suitable for both displaying information and receiving touch screen inputs. Alternatively, a variety of switches, buttons, and other input devices may be utilized instead of, or in addition to, a touch screen device. The display 204 may be configured to display a variety of desired information such as RTB speed, weather, water depth, and/or other useful information concerning the RTB 100 and operations thereof including, but are not limited to, various service alerts, such as low oil pressure, low battery voltage, low water depth, bad weather conditions, or the like, and/or operational alerts such as shallow water, bilge pump status, or the like.

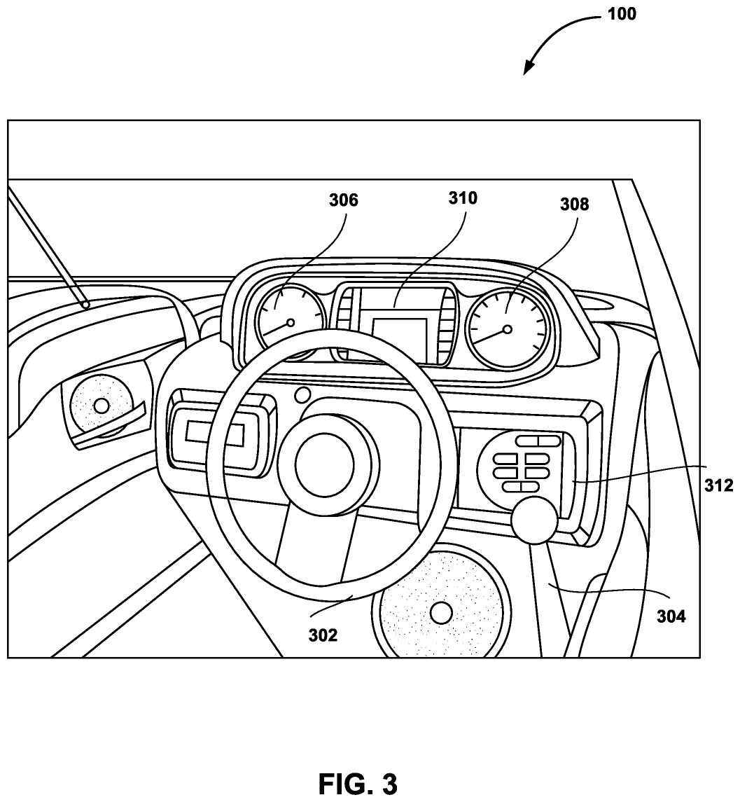

FIG. 3 is a diagram that illustrates a prospective view of an exemplary cockpit of the RTB 100, according to an exemplary embodiment of the present invention. The RTB 100 may include a steering wheel 302 and a throttle control 304. The RTB 100 may further include a tachometer 306 and a speedometer 308. In addition, the RTB 100 may further include a graphical display 310 and an input device 312. The graphic display and the touch screen are operably connected to or integrated with the controller 202. In the illustrated embodiment, the input device 312 is a discrete touch screen, however, one will appreciate that the graphic display 310 and the input device 312 may be integrated into a single device, for example, a single screen that is suitable for both displaying information and receiving touch screen inputs. The display 310 may be configured to display a variety of desired information such as RTB speed, weather, water depth, and/or other useful information concerning the RTB 100 and operation thereof including, but are not limited to, various service alerts, such as low oil pressure, low battery voltage, or the like, and/or operational alerts such as shallow water, bilge pump status, bad weather conditions, or the like. The input device 312 may be configured to receive a variety of input commands from an operator (e.g., a driver) of the RTB 100.

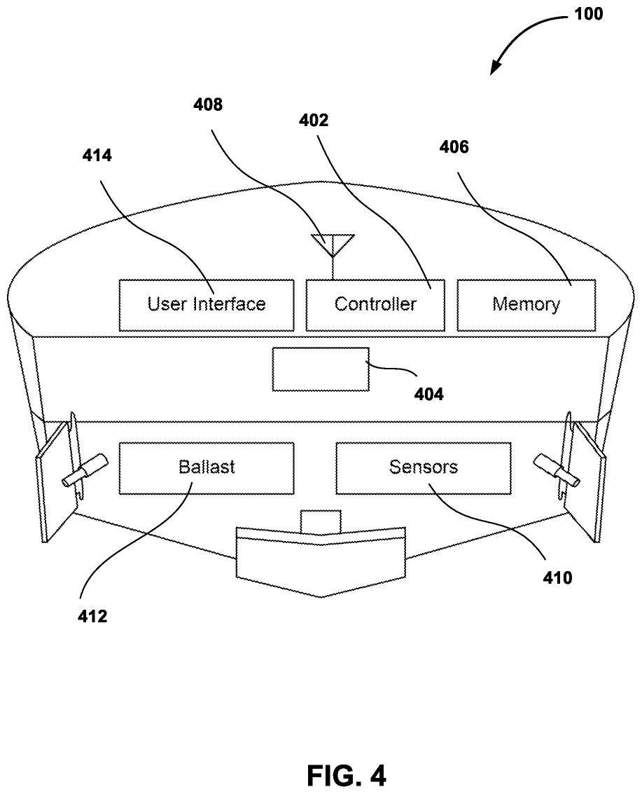

FIG. 4 is a diagram that illustrates an exemplary data and visualization center of the RTB 100, according to an exemplary embodiment of the present invention. The data and visualization center of the RTB 100 may be communicatively coupled to one or more remote devices or servers, such as a participant mobile device, an operator mobile device, an application server, a database server, or the like, over one or more communication networks. The data and visualization center of the RTB 100 may create a network of multiple tow watercrafts during recreational activities to provide an extended level of system operation, control, and optimization. For example, the acquired data and the generated trends may be discernment to the one or more tow watercrafts for facilitating ease of operation and control, along with the extended optimization. These data and trends may be rendered via one or more application portals (i.e., software applications) running on one or more respective devices such as user devices or tow watercraft devices. In addition to this, the present invention also discloses capturing, transferring, and using user data. The main purposes include data collection and mining, machine learning, social sharing, or the like.

The data and visualization center may include a controller 402, a notification element 404, a memory 406, a communication interface 408, one or more sensors 410, a ballast 412, and a user interface 414. In an embodiment, the user interface 414 may include a button that corresponds to a relatively linear left-side surf wake, a button that corresponds to a relatively linear right-side surf wake, a button that corresponds to a relatively curved left-side surf wake, and a button that corresponds to a relatively curved right-side surf wake. Additional buttons may be included for selecting other wake types or other wake features (e.g., wake height, length, or the like). The user interface 414 may include other buttons for specified preset wake types. The user interface 414 may include user input elements (e.g., buttons) that allow the operator to adjust one or more aspects (e.g., wake height, length, steepness, etc.) of the wake. The user interface 414 may permit the operator to store the adjusted settings (e.g., in the memory 406) for later use. The controller 402 may be configured to adjust multiple features (e.g., water diverters, wedge, and/or ballast) based on the selection of a single wake-type button. The controller 402 may also adjust the ballast 412, as well as other wave shaping features such as trim tabs, watercraft speed, positions of the water diverters, or the like to produce the selected wake type. In some embodiments, the controller 402 may be configured to set the watercraft speed, or to present a recommended watercraft speed. In some embodiments, the controller 402 may set the watercraft speed upon the selection of the wake type. In some embodiments, the controller 402 may determine a recommended watercraft speed and may communicate (e.g., via a visual display or an audio speaker) the recommended watercraft speed to the operator (e.g., a driver). In some embodiments, the amount or distribution of the ballast can be changed by the controller 402 in response to a selection of a wave type by the operator. The ballast (e.g., water held in containers in the RTB 100) can be automatically moved from one side of the RTB 100 (e.g., right side) to the other side of the RTB 100 (e.g., left side) based on a selection that changes the surf or ski or recreational wake from one side to the other. The distribution of the ballast may be changed by the controller 402 based on a selection of a wake type by the operator. In response to the selection of the wake type, the controller 402 may automatically move ballast in the RTB 100 from the front to the rear or from the rear to the front of the RTB 100. In some embodiments, the controller 402 may consider both static variables (such as the type of tow watercraft) and dynamic variables (such as the depth of water, the number of passengers or participants on board, etc.) when setting the wake shaping features to achieve a specified wake type. Because the dynamic variables can have different values at different times, the controller 402 may be configured to adjust the wake shaping features differently at different times even when trying to achieve the same wake type. For example, the controller 402 may use less ballast 412 when more passengers or participants are on the RTB 100. In some embodiments, the controller 402 may be configured to adjust the wake shaping features on the fly, while the tow watercraft is moving, for example, to try and keep the wake consistent when dynamic variables change. For example, if the depth of water under the RTB 100 changes, the shape of the wake can also change, and the controller 402 may be configured to adjust the wake shaping features to compensate for the change in water depth to minimize the change in shape in the wake. In some embodiments, the RTB 100 may include the sensors 410 to sense and measure static or dynamic variables. For example, a water depth sensor may be included. A watercraft speed sensor may be included, especially where the operator is permitted to adjust the speed of the tow watercraft. The RTB 100 may include weight sensors for determining how much passenger or participant weight is on the RTB 100 and/or the distribution of the passenger or participant weight. Other sensors such as image, Lidar, Radar, Sonar, GPS sensors, or the like may be included in the RTB 100 for collecting the image data, Lidar data, Radar data, Sonar data, and GPS data of the participant and other personnel in and around the RTB 100. Using the Sonar, Lidar, Radar, Visual, and GPS data, the controller 402 may facilitates location tracking of all stakeholders and manage movements to safely operate tow watercraft recreational activities. The aim is to find the participant during the recreational activity, keep a track of the participant, detect one or more objectionable items in the vicinity of the participant, and avoid everything else. In case of any accidental events or mishap during the recreational activity, the operator (such as the driver or observer of the RTB 100) notifies or signals that the participant is down. Such notifications or signals may be communicated to rescue personnel or other watercrafts in its vicinity. Signaling may be achieved with multiple modalities. These include, but are not limited to, auditory, visual, mechanical, or any combination thereof.

In some embodiments, the user interface 414 may be configured to receive input from the operator regarding at least some of the dynamic variables. For example, the user interface 414 may allow the operator to specify a number of passengers or participants on the RTB 100 and/or the distribution of the passengers or participants on the RTB 100. In some cases, the memory 406 may store different settings for different participants, to account for the individual preferences. The user interface 414 may allow the operator to identify any specific participant. In some embodiments, settings and/or algorithms for particular wake shapes may be downloaded to the memory 406 from a remote source such as a data center.

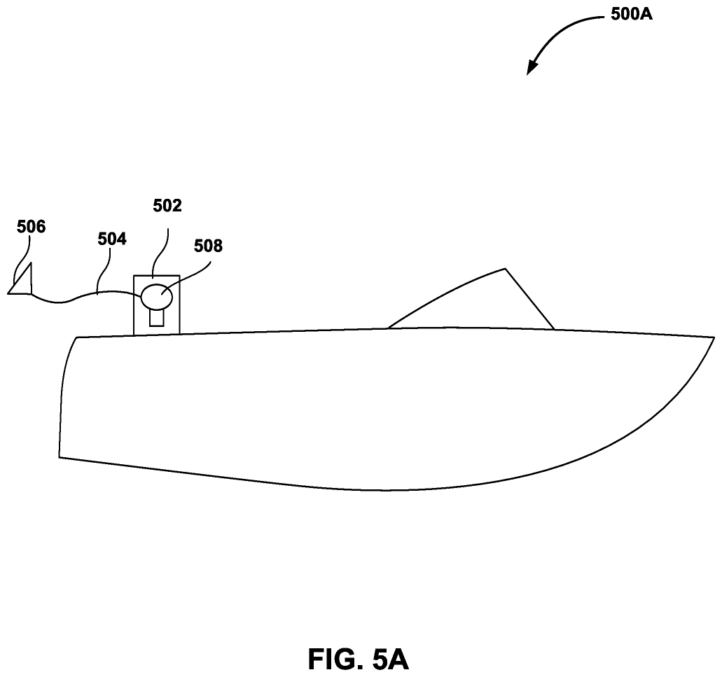

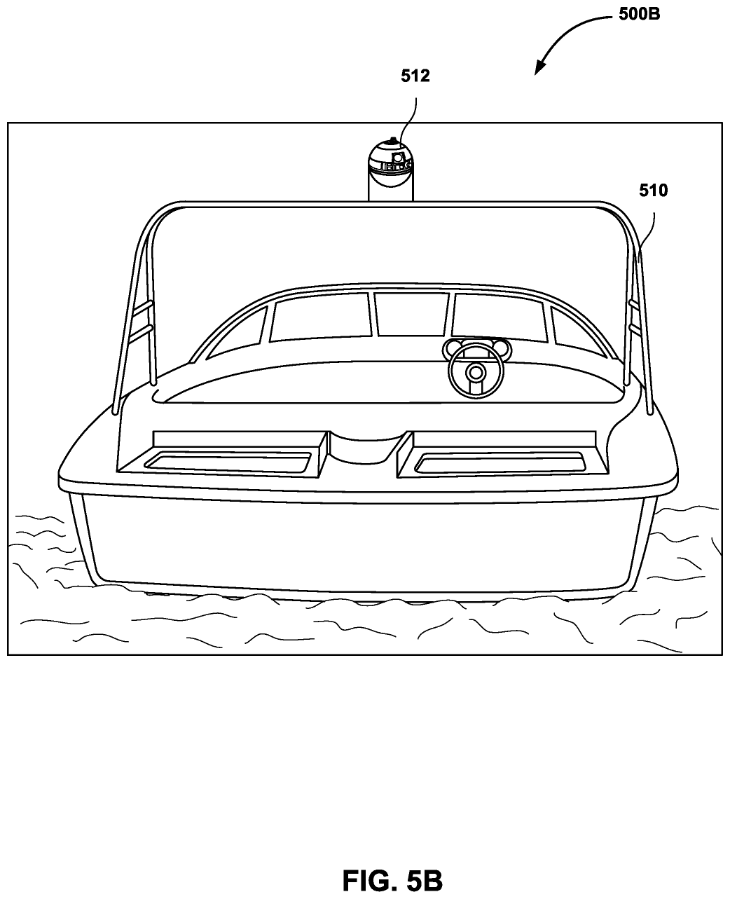

FIG. 5 is a diagram that illustrates an exemplary retractable tow rope 504 of the RTB 500A, according to an exemplary embodiment of the present invention. In an embodiment, one end of the retractable tow rope 504 may be attached to a rope retracting mechanism 508 of the RTB 500A and another end may be attached to a handle 506. Further, in some examples, the rope retracting mechanism 508 may be placed inside a rope retracting chamber 502 of the RTB 500A and installed at a backside platform of the RTB 500A. In another example, the rope retracting mechanism 508 may be installed on a Bimini top of the RTB 500A. In some embodiments, the rope retracting mechanism 508 may be included or integrated inside in an RTB controlling device of the RTB 500A. The RTB controlling device (as shown and described later in detail in conjunction with FIGS. 5B, 7, 8, and 9) may be installed on the backside platform or Bimini top of the RTB 500A.

In an exemplary embodiment, a participant may hold on to the handle 506 of the tow rope 504 during the start of a towable run. The tow rope 504 may pull the participant up out of the water as the RTB 500A starts moving. In some instances, the tow rope 504 may interfere with the participant. For example, a participant may toss the tow rope 504 aside, but the flow of water may drive the tow rope 504 back towards the participant, which can cause the participant to fall and/or become tangled in the tow rope 504. When the participant releases the tow rope 504, a passenger or an observer in the RTB 500A may gather the tow rope 504 into the watercraft, which can be burdensome on the passenger or the observer. In some embodiments, the RTB 500A may include the retractable tow rope 504. The tow rope 504 can automatically retract (e.g., into a rope retracting chamber 502 of the RTB 500A) when the participant releases the tow rope 504. The rope retracting mechanism 508 may include a spool that is rotatable about an axis. The tow rope 504 may be coupled to the spool such that rotation of the spool in a first direction causes the tow rope 504 to wrap around the spool. Accordingly, rotation of the spool in the first direction can cause the tow rope 504 to be gathered into the rope retracting mechanism 508. Rotation of the spool in a second direction can release the tow rope 504 from the spool, which can allow the tow rope 504 to exit the rope retracting mechanism 508. The rope retracting mechanism 508 may include a spring coupled to the spool such that rotation of the spool in the second direction causes potential energy to build up in the spring. When the participant releases the tow rope 504, the tow rope 504 may be automatically retracted to the RTB 500A. In some embodiments, the tow rope 504 may be locked at a desired length. For example, one or more engagement features on the spool may be selectively engaged by one or more locking features, which can lock the spool in place, thereby preventing the spool from retracting the tow rope 504 and/or preventing the spool from releasing more of the tow rope 504. An actuator (e.g., a button or lever) may be configured to engage and/or disengage the locking features and the engagement features. To lock the tow rope 504 at a particular length, the tow rope 504 may be extracted to the particular length, and the actuator can be actuated to engage the locking features with the engagement features. Different participants may prefer to use different lengths of the tow rope 504. Different lengths of the tow rope 504 may be preferable for different recreation types and settings. Accordingly, in some embodiments, a maximum length of the tow rope 504 may be set such that the spool is impeded from rotating further in the second direction. The spool may be permitted to rotate in the first direction. Thus, in some embodiments, when the locking mechanism is activated, the length of the tow rope 504 behind the RTB 500A may only shorten and cannot increase in length. In some embodiments, the locking mechanism can include a ratchet system, e.g., which can include one or more pawls and one or more teeth. When engaged with each other, the pawls and teeth may be configured to ratchet in a first direction to allow the spool to rotate in the first direction to retract the tow rope 504 and to prevent rotation of the spool in the second direction.

In addition, the tow rope 504 may be provided with a rope resistance mechanism to create drag for proper spooling. One end of the tow rope 504 may be electromagnetically coupled to the rope retracting mechanism 508 or the RTB controlling device of the RTB 500A. Further, one or more life vests may be provided for the participants during the tow watercraft recreational activities. The life vests may include one or more sensors (such as location beacons) to indicate middle of 45-degree launch trajectory and distance needed to retract to bring the handle 506 to the participant. Further, one or more surf boards may be provided that may be used by the participants to perform the tow watercraft recreational activities. The surf boards may also include one or more sensors for location tracking during the recreational activities. The surf boards may also be provided with one or more bots for retrieval. Further, one or more smart towable rafts may be provided that may be used by the participants to perform the tow watercraft recreational activities. The smart towable rafts may indicate and communicate relevant signals when the participants feel off during the recreational activities. The smart towable rafts may be integrated with one or more cameras that are configured to capture images or videos in real time and communicate the same to a controller of the RTB 500A or a remote server. Further, one or more smart wake boards may be provided to release the rope coupling when edge catches to prevent blood nose and concussion. In some embodiments, the participants may be able to change the RTB parameters, speed, wavelength size, or the like. Further, the tow rope 504 may be of monofilament style that can light up and float in the water and is easy to view. Further, weight and size of the tow rope 504 may be chosen such that it maximizes minimal space.

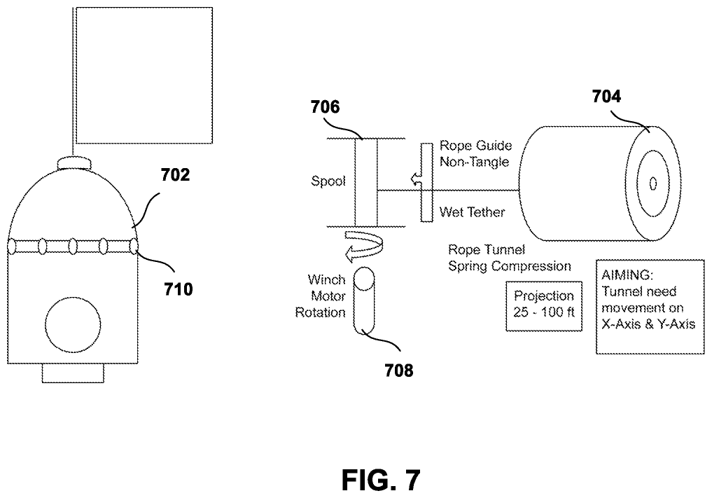

FIG. 5B is a diagram that illustrates an exemplary RTB controlling device 512 attached to a Bimini 510 of the RTB 500B, according to an exemplary embodiment of the present invention. The Bimini 510 is an open-front canvas top for the cockpit of a watercraft such as the RTB 500B, usually supported by a metal frame. Most Biminis can be collapsed when not in use and raised again if required. In an embodiment, the RTB controlling device 512 may be attached to a top portion of the Bimini 510. The RTB controlling device 512 may include one or more sensors (such as GPS sensors, Lidar, Radar, or the like) for sensing and recording one or more parameters with respect to height, length, depth, location, or the like. The RTB controlling device 512 may further include one or more cameras (for example, a 360-degree camera) that are configured to capture and record one or more images and videos of the participant and its surrounding environment. The RTB controlling device 512 may further include the rope retracting chamber 502 integrated with the tow rope 504 along with the rope retracting mechanism 508. The RTB controlling device 512 may further include one or more transceivers that are configured to communicatively connect with one or more devices or servers such as a participant mobile device, an operator mobile device, an application server, a database server, or the like, over one or more communication networks and communicate the recorded data. The recorded data may be processed to identify one or more tow watercraft recreational trends, or any mishaps associated with the participant. The collected data may be used for mining the trends, machine learning, social sharing, or the like. This helps in automating and enhancing situational awareness for enabling safe towable recreation. The RTB controlling device 512 has been further described in detail in conjunction with FIGS. 7, 8, and 9.

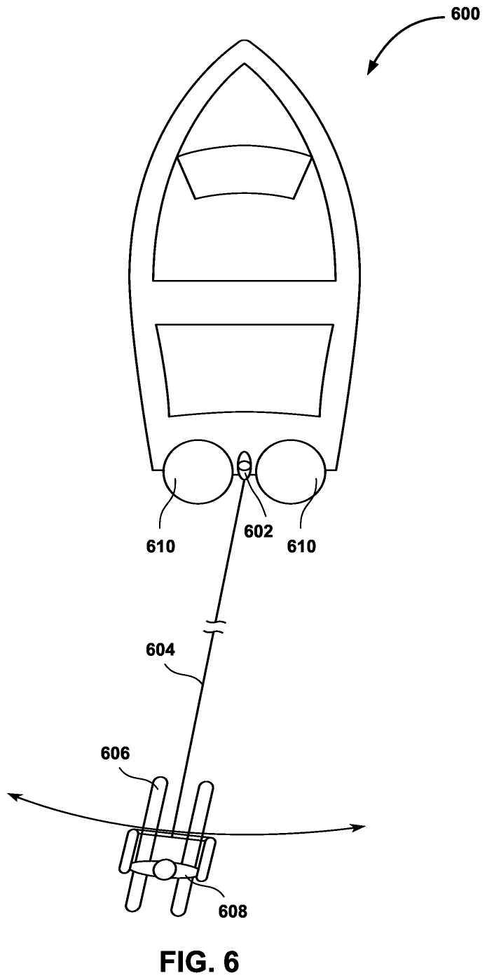

FIG. 6 is a diagram that illustrates a top view of the RTB 600 towing a participant 608, according to an exemplary embodiment of the present invention. The RTB 600 is schematically illustrated having a pylon 602 (of the rope retracting mechanism 508 in the RTB controlling device) mounted to a stern or Bimini of the RTB 600. One end of a tow rope 604 is attached to the pylon 602 and its opposite end connects to a handle or connector 606 that may be grasped by the participant 608. Typically, the participant 608 moves in a side-to-side direction during a towable run, illustrated generally by an arrow, crossing the wake (not shown) produced by the motors 610 of the RTB 600.

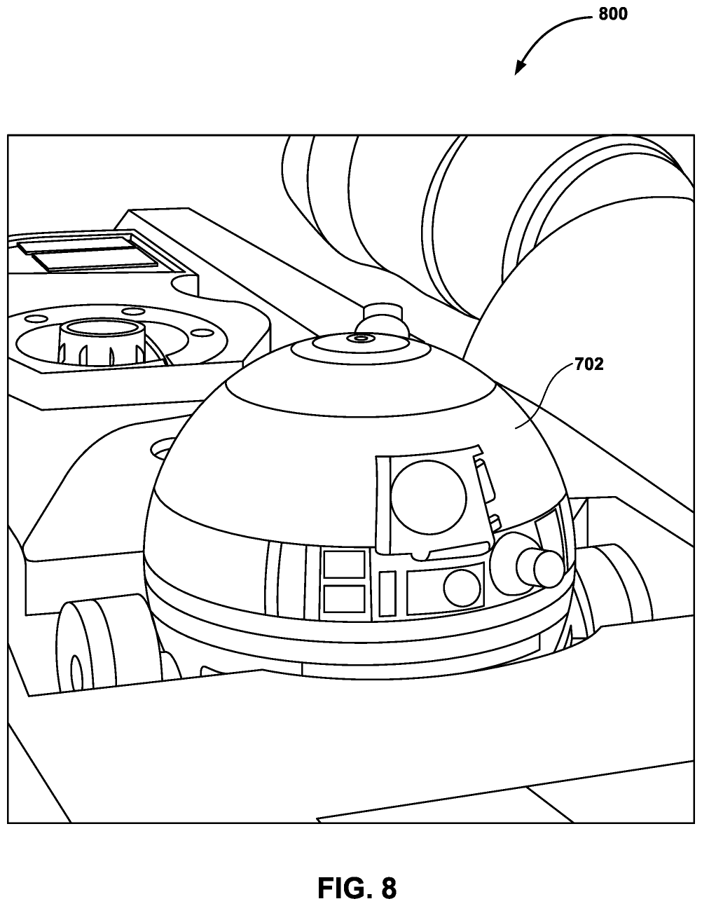

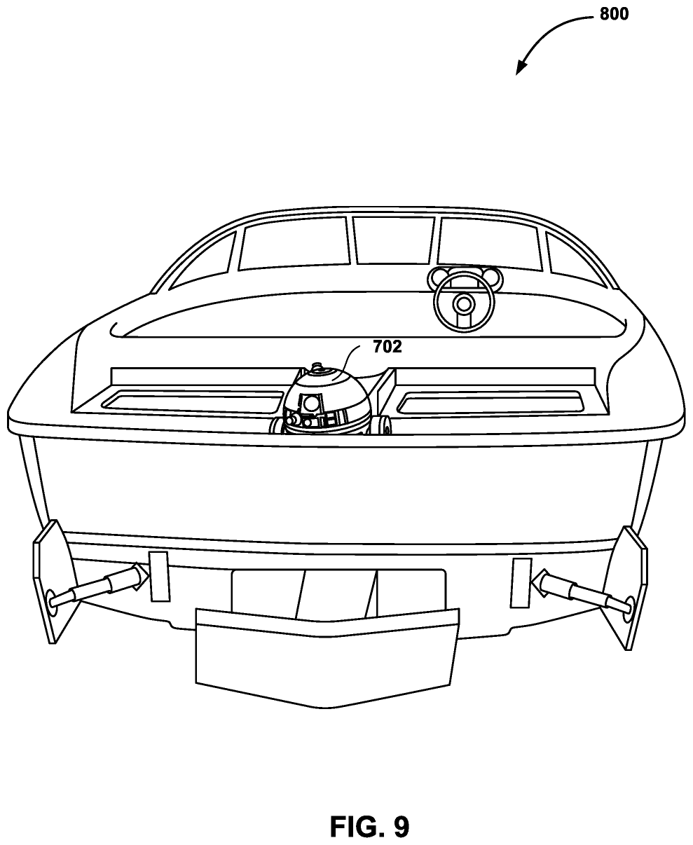

FIG. 7 is a diagram that illustrates a high-level RTB controlling device 702, according to an exemplary embodiment of the present invention. The RTB controlling device 702 includes a rope tunnel and spring compression 704, a spool 706, and a motor 708. The RTB controlling device 702 further includes the sensors 710. FIGS. 8 and 9 are diagrams that illustrate the RTB controlling device 702 integrated with the RTB 800, according to an exemplary embodiment of the present invention. The RTB controlling device 702 facilitates the following features and advantages. For example, in one embodiment, the RTB controlling device 702 facilitates improved situational awareness. A rear mounted camera (such as a 360-degree image sensor 710 of the RTB controlling device 702) may allow the operator driving the RTB 800 to look forward with having one or more images of the participant projected in their field of view. The images may be displayed on the display 204 or the user interface 414. Examples of the display may include a tablet, LCD display, laptop, cell phones, heads up display or hologram. The images may be merged along with the position information for screen overlays including other watercrafts, buoys, speeds, RPM, temperature, depth, height, wind direction, rain forecasting, or any combination thereof. Length of the current tow run and a time of aggregate recreating for the day to monitor fatigue may also be displayed. The camera used for the application may be a wide-angle camera, a 360-degree camera, an infrared camera, or any combination thereof.

In an embodiment, the RTB controlling device 702 integrates these primary functions:
Controller=Outputs
Sensors=Inputs
Memory=Data acquisition & discernment to one or more Vessels, Participants, Equipment
Engagement=App Portal
Networking=Connectivity of one vessel (RTB) to the other like vessels (RTBs)

The controller of each RTB may be configured to receive input or provide output, for example:
1. Input from the Towing Vessel
   a. Vessel=Tow Watercraft (vs. water skiing watercraft)
   b. Vehicle=next series
      i. Jet Skis
      ii. Recreational Vehicle—RV
      iii. Off Road Vehicles
         1. 4×4
         2. Razor
         3. ATV
         4. Snowmobile
2. Output to the Vessel
   a. Modification of functions
      i. Power
      ii. Actuation
      iii. Gears
3. Input from the Participant
   a. Location
   b. Status
   c. Orders/Direction
4. Output to the Participant
   a. Warnings
   b. Data on Equipment (location etc.)
5. Input from the Equipment
   a. Location
   b. Status
   c. Orders/Direction
6. Output from the Equipment
   a. Location
   b. Status
   c. Orders/Direction
7. Watercraft BOTZ (i.e., RTB controlling device)
   a. Functionality of the Tow Botz (i+ii+iii=RCW 79A.60-170)
      i. Rope management
         1. Projection
         2. Retraction
      ii. Warning to Surroundings (visual, audible, signaling program)
         1. Driver that participant is down
         2. Local Vicinity—that Participant is in the water
         3. Participant—others are aware
      iii. Connection—(‘touch’ via rope/equipment, ‘sight’ via camera/lidar/radar/sonar/etc.)
         1. Recreational Vehicle
         2. Participant Recreational Equipment
      iv. Networking Awareness
         1. Other Botz (other RTB controlling devices)
      v. Data Sharing Portals
         1. Engagement for Apps/Refinement/Other
8. Engagement Output Portal
   a. Data culmination, protection & interface
9. Engagement Input Portal
   a. Apps or Outside sources
   b. Protection/safety & summary
10. Output to the Network of other BOTZ
11. Input to the Network BOTZ

In an embodiment, the controller 202 or 402 in conjunction with the RTB controlling device 702 further facilitates automatic delivery of a rope handler (such as the handle 506) with safety as the primary concern.
a. People avoidance—Safety
   i. Dual position identification. Compare RFID info with Camera.
   ii. Sound Alarm before launch.
   iii. Audio command from any passenger or participant can terminate the launch sequence.
   iv. “Nerf” material at the launch end of the rope that provides both aerodynamics and a safe level of cushioning in case of contact, while still meeting the all the functionality requirements necessary to pull a participant.
b. Target Identification
   i. GPS
   ii. Camera Imaging
   iii. Thermal Imaging
   iv. Geo-Fencing
   v. RFID
   vi. Combinations of the above to confirm position and relative position to the tow watercraft
c. Target Distance Calculation
   i. Basic algorithm
   ii. Differential GPS positions
   iii. Laser distance measuring
   iv. Sonic/Sonar
   v. RFID
   vi. Combinations of the above for confirmation.
d. Target Parameters
   i. Weight
   ii. Height
   iii. Experience Level
   iv. Inebriation
   v. Fatigue

In an embodiment, the controller 202 or 402 in conjunction with the RTB controlling device 702 facilitates automatic notification of the participant who is down during the tow watercraft recreational activities. The RTB controlling device 702 performs:
a. Flag Management
   i. Raise a Flag automatically
   ii. Based on watercraft speed
   iii. Rope tension
   iv. Verbal commands from any passenger
   v. Combination
b. Illumination Device
   i. To be seen
   ii. To view a target
c. Send a discrete signal to related systems on watercraft.
   i. System interoperability

In an embodiment, the RTB controlling device 702 further facilitates various types of connectors such as a watercraft to rope connector. This may be a smart rope that can automatically retract as per the requirement and applications of use. The smart rope is configured to maintain steady state, impulse, and torque during its use during the recreational activities. Other connector may include a rope to participant connector that can also automatically connect and release. This connector may be based on magnetics and advance material properties.

In an embodiment, the RTB controlling device 702 further facilitates path optimization based on real time conditions. One or more condition parameters may include, but are not limited to, other watercraft(s), other participants, wind, visual conditions, temperature, fuel quantity, engine horsepower, watercraft weight, viscosity, passengers, water depth, or the like.

In an embodiment, the RTB controlling device 702 further facilitates path or course optimization based on the participants' preferences or degree of difficulty. The degree of difficulty may be identified based on a category of the participant such as whether the participant is a child, a beginner, an intermediate, an expert, a stuntman, or women, a disabled, a blind, a deaf, or a limb deficiency.

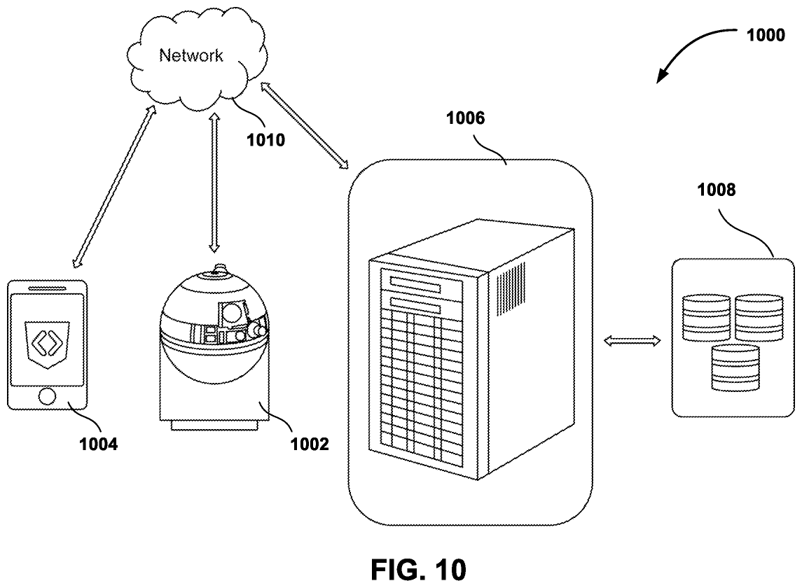

In another embodiment, the RTB controlling device 702 further facilitates network coupling (i.e., communicative coupling) among various entities. For example, FIG. 10 is a diagram that illustrates a network engagement 1000 of the RTB controlling device 1002 with one or more remote devices or servers, according to an exemplary embodiment of the present invention. The one or more remote devices or servers may include a mobile device 1004 associated with a participant, an operator, or other participant or passenger, an application server 1006, and a database server 1008.

The application server 1006 is a computing device, a software framework, or a combination thereof, that may provide a generalized approach to create the application server implementation. Examples of the application server 1006 include, but are not limited to, a personal computer, a laptop, or a network of computer systems. The application server 1006 may be realized through various web-based technologies such as, but not limited to, a Java web-framework, a .NET framework, a PHP (Hypertext Preprocessor) framework, or any other web-application framework. The application server 1006 may operate on one or more operating systems such as Windows, Android, Unix, Ubuntu, Mac OS, or the like. Various operations of the application server 1006 may be dedicated to execution of procedures, such as, but are not limited to, programs, routines, or scripts stored in one or more memory units for supporting its applied applications and performing defined operations. For example, the application server 1006 may be configured to collect the data from one or more data sources such as the RTB controlling device 1002 of the one or more RTBs. The collected data may be stored in the database server 1008. The database server 1008 may include suitable logic, circuitry, interfaces, and/or code, executable by the circuitry that may be configured to perform one or more data management and storage operations such as receiving, storing, processing, and transmitting queries, data, or content. In an embodiment, the database server 1008 may be a data management and storage computing device that is communicatively coupled to the application server 1006 or the mobile device 1004 via the network 1010 to perform the one or more operations mining, machine learning, social sharing, or the like.

The RTB controlling device 1002 may be configured to establish a network (such as the communication network 1010) among the devices or servers and other tow watercrafts via the one or more communication networks such as the communication network 1010. The communication network may include suitable logic, circuitry, interfaces, and/or code, executable by the circuitry, that may be configured to transmit queries, messages, data, and requests between various entities such as all other watercrafts in its vicinity. Examples of the communication network may include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Various entities may be coupled to the communication network in accordance with various wired and wireless communication protocols, such as Transmission Control Protocol and Internet Protocol (TCP/IP), User Datagram Protocol (UDP), Long Term Evolution (LTE) communication protocols, or any combination thereof. In an exemplary embodiment, the communication network may be a controlled area network (CAN) bus. The CAN bus provides a common communication channel to various devices and components installed in the watercrafts for communicating with each other. The CAN bus is a message-based protocol that allows the various devices and components connected therewith to communicate with each other. In an embodiment, the RTB controlling device 702 may create or establish the network 1010 among the multiple participants, drivers, and/or tow watercrafts during recreation activities to provide an extended level of system operation, control, and optimization. For example, the acquired data and the generated trends may be discernment to the one or more tow watercrafts or the mobile devices of one or more drivers of the one or more tow watercrafts on the lake for facilitating ease of operation and control, along with the extended optimization. These data and trends may be rendered via one or more application portals (i.e., software applications) running on one or more respective devices such as mobile devices 1004 or tow watercraft devices. In addition to this, the present invention also discloses capturing, transferring, and using user data. The main purposes include data collection and mining, machine learning, social sharing, or the like

In an embodiment, the RTB controlling device 702 further facilitates big data analytics based on the data collected from the various sensors such as water depth, watercraft speed, weight, image, Lidar, Radar, Sonar, or GPS sensors. As the components of the recreational equipment become connected to the Internet, the big data analytics may be incorporated to identify trends that can be leverage for further product optimization. The Sonar data, Lidar data, Visual data, and Position data may be collected and processed in real time to track movements in and around the watercraft and participant and automatically generate signals in case of one or more emergency situations.

In another embodiment, the RTB controlling device 702 further facilitates communication links between two or more entities (such as Watercraft to Watercraft, Watercraft to Shore, Watercraft to Satellite, Watercraft to Participant, Driver to Participant, Participant to Driver, Watercraft to Server, or the like) over the one or more communication networks.

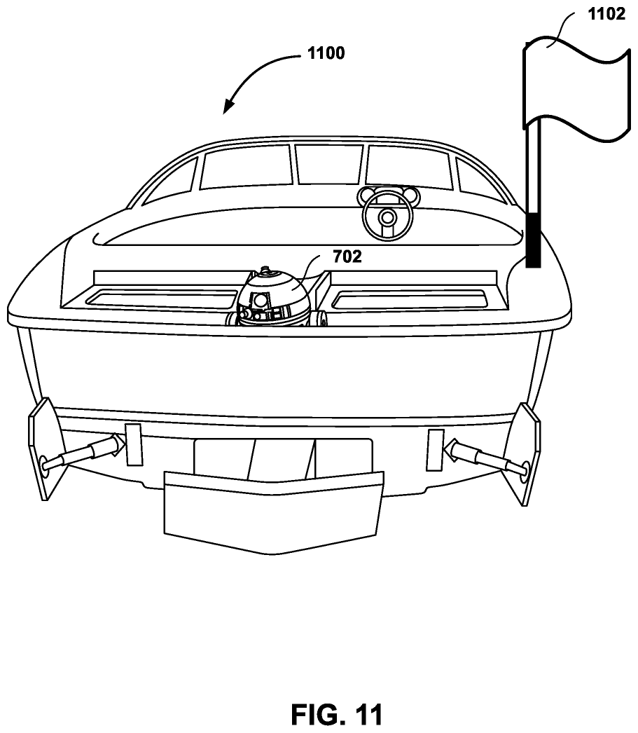

FIG. 11 is a diagram that illustrates an automatic safety flag 1102 on the RTB 1100, according to an exemplary embodiment of the present invention. The flag 1102 is attached to a front, rear, or side portion of the RTB 1100. The flag 1102 may be mechanically operated to move its position and stabilize. The flag 1102 may also be electronically controlled by means of a control device. An operator (such as driver i.e., captain of the RTB 1100) may control the flag 1102, either mechanically or electronically, to ON or OFF the flag 1102, or to move the flag 1102 UP or DOWN, or to waive or reset the flag 1102. The power source required to control the various operations of the automatic safety flag 1102 may include direct wiring, plug-in cord, or one or more in-built batteries. In one example, the automatic flag 1102 may be powered by the RTB controlling device 702. The flag 1102 may be connected to one or more alarms or FOBs over a wireless or wired network or by means of an IOT device. The information screen of the RTB 1100 may be configured to confirm connection and status of the flag 1102 with the one or more alarms and FOBs. For example, it may display real time status of alarms, FOBs, or flags.

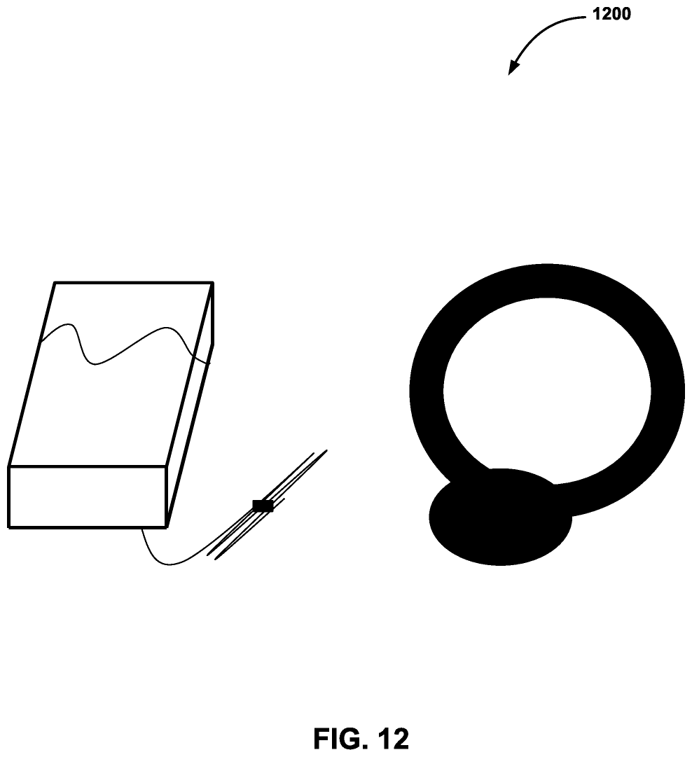

FIG. 12 is a diagram that illustrates a captain's alarm 1200, according to an exemplary embodiment of the present invention. The captain may be an individual who is driving and controlling the RTB (as shown in previous figures). The captain's alarm 1200 is one embodiment of the alarm disclosed herein. The alarm 1200 may be configured to alert the captain of the RTB 1100 in case of any mishappening with one or more participants i.e., riders or swimmers. The alarm 1200 may be attached to a watercraft such as the RTB 1100 (shown in FIG. 11). It may include a visual light signal, an auditory signal (with alarm and radio volume turned down option), and a vibration signal (bracelet) as shown. The alarm 1200 may include a motor kill switch option which is neutral when the participant's FOB is in water. The alarm 1200 may be manually turned ON or OFF and may be wirelessly connected to the one or more FOBs and the flag 1102. The alarm 1200 may be configured to include a location sensor (such as GPS, Gyro, or Accelerometer) for measuring and keeping a record of the current location. The alarm 1200 may be configured to communicate an SOS signal to other not on the watercraft in case of an emergency event. The alarm 1200 may be powered by direct wiring, plug-in cord, or one or more in-built batteries. The information screen of the RTB 1100 may be configured to confirm connection and status of the alarm 1200 with the one or more flags and FOBs. For example, it may display real time status of alarms, FOBs, or flags. The alarm or the flags may be controlled using a mobile application running on a mobile device.

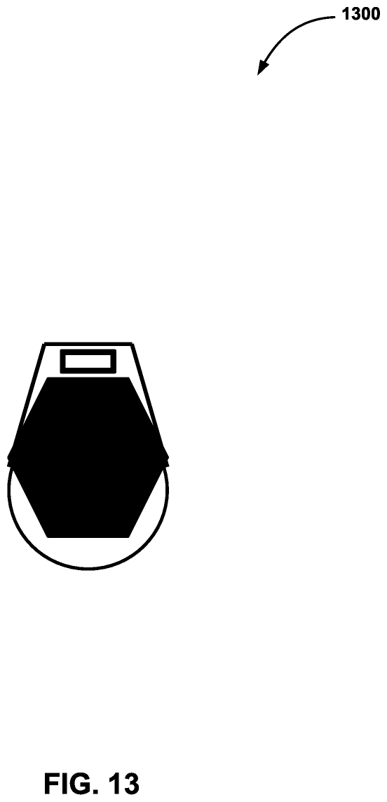

FIG. 13 is a diagram that illustrates an FOB device 1300 for a participant, according to an exemplary embodiment of the present invention. The FOB 1300 is an immersion sensor that is configured to sense in case a holder is submersing into the water. In an embodiment, up to 8 FOBs may be paired with the flag 1102 and up to 30 FOBs may be paired with the captain's alarm 1200. The captain's alarm 1200 is one embodiment of the alarm. The FOB 1300 is enclosed inside a waterproof case and is wirelessly connected to the one or more alarms 1200 and the flag 1102. The FOB 1300 may be configured to a location sensor (such as GPS, Gyro, or Accelerometer) for measuring and keeping a record of the current location. The FOB 1300 may be powered by one or more in-built batteries. The FOB 1300 may include an information light source and indicates charge level and ON or OFF scenario.

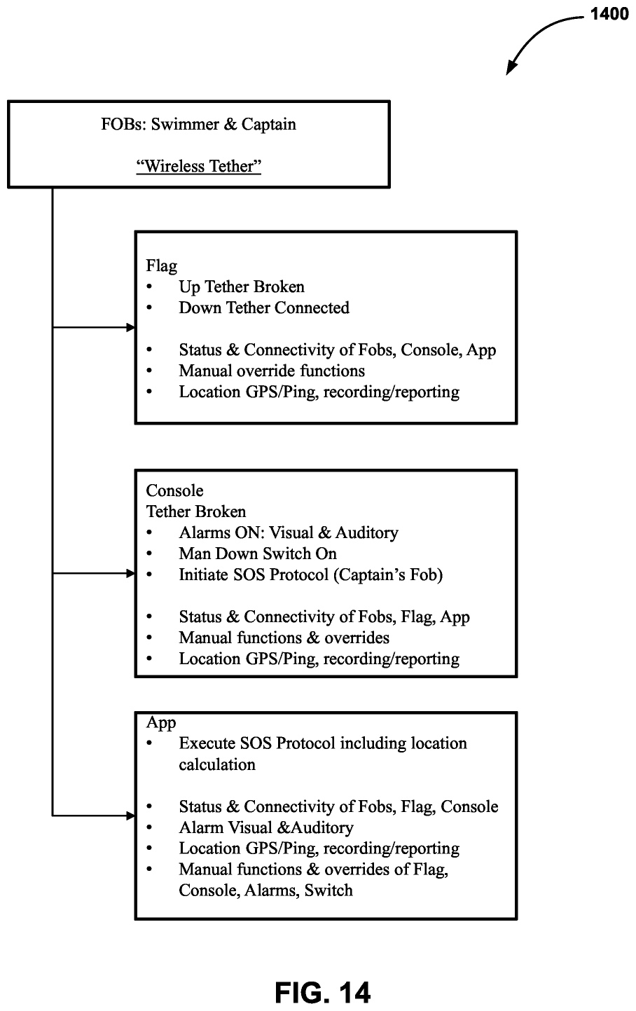

FIG. 14 is a diagram that illustrates wireless tethering of FOBs of swimmers and captain, according to an exemplary embodiment of the present invention. The flag 1102, the alarm 1200, and the FOB 1300 may be communicatively connected to each other over wireless network known in the art without limitation. The flag raising or deployment lets the surrounding watercraft to know that a participant is in the water. The alarm lets the captain know that the participant is submerged in the water. The participant's FOB is in constant communication with the flag and the alarm. When the participant gets submerged in the water, the communication is ceased, thus initiating the flag to go up automatically and alarm the captain.

As discussed above, there are 7 main components such as smart flag, captain's console, captain's FOB, swimmer's FOB, smart device application (App), SOS protocol, and man down switch. The first 6 components depend on the wireless communication (such as Wi-Fi, Bluetooth, IOT, etc.). The man down switch, which must be installed, puts the watercraft's gear into neutral and if desired can lower the volume of the watercraft's radio when participant is submerged in the water. The current range of the wireless communication from the FOB to the smart flag and caption's console is 240 feet when in direct line of sight, which is the case with water sports. The direct line of communication acts as a wireless tether connecting the FOBs to the captain's console and the smart flag. When the Fobs are submerged in the water, the tether is broken, which then activates the console, the flag, the alarm, and the app. The smart flag activates rising into position and noting it's GPS location. In addition to the activation, the flag has manual buttons for UP, DOWN, WAVE, and RESET functions. The smart flag is also capable of indicating its connection and the status of the FOBs, captain's console, the App. The captain's console activates both visual and auditory alarms, the Man down switch if installed, GPS location via the App, and the SOS protocol if the captain's FOB broke its tether. The SOS alarm triggers rescue protocol on the smart device via AIS, text, call for help etc. The captain's console will also mark GPS location when FOB tethers are broken. The captain's console has manual buttons for controlling functions of the flag, the man down switch, SOS protocol activation, and the connectivity to FOB's and App's on smart devices. The smart device App may be configured to alarm the captain when the swimmers is in the water along with their location. The location information may include location of the flag, the captain's console, and FOBs. The smart device App may provide status on the system, activate SOS protocol, and provide information and direction. The watercraft may include a kill engine or switch that is ignited to turn OFF an ignition system of the watercraft. Generally, the spring action within the kill engine or switch breaks the electric circuit of the engine ignition system, thereby turning OFF, or “killing” the engine of the watercraft.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims. Although particular embodiments of the invention have been described in detail for purposes of illustration, various modifications and enhancements may be made without departing from the spirit and scope of the invention. The scope of the invention is accordingly defined by the following claims.

We claim:

1. A system to sense immersion of a participant into water, comprising:
an alarm device of a watercraft,
an FOB device of a participant, wherein,
the alarm and the FOB device are wirelessly connected to each other,
the FOB device detects the immersion of the participant in the water, and
the alarm device is automatically turned ON creating an alarm indicating an SOS signal.

2. The system of claim 1, further comprising a smart flag, wherein the smart flag is wirelessly connected to the alarm and the FOB, and wherein the smart flag is automatically deployed based on the detected immersion.

3. The system of claim 2, wherein, when the participant gets submerged in the water, the communication is ceased, thus initiating the flag to go up automatically and alarm a captain of the watercraft.

4. The system of claim 3, wherein deployment of the flag lets surrounding watercraft to know that the participant is in the water.

5. The system of claim 1, wherein the alarm lets a captain of the watercraft know that the participant is submerged in the water.

6. The system of claim 2, wherein the participant's FOB is in constant communication with the flag and the alarm.

7. The system of claim 2, further comprising a captain's console, a captain's FOB, a smart device application, an SOS protocol, and a man down switch.

8. The system of claim 7, wherein the man down switch puts the watercraft's gear into neutral and if desired can lower the volume of the watercraft's radio when the participant is submerged in the water.

9. The system of claim 7, wherein the console, the flag, the alarm, and the app are activated when the FOBs are submerged in the water and tether is broken.

10. The system of claim 9, wherein the flag activates rising into position and noting it's GPS location after the tether is broken.

11. The system of claim 10, wherein the flag is also capable of indicating its connection and status of the FOBs, captain's console, and App.

12. The system of claim 7, wherein the captain's console activates both visual and auditory alarms, the Man down switch if installed, GPS location via the App, and the SOS protocol if the captain's FOB broke its tether.

13. The system of claim 12, wherein the captain's console is configured to mark GPS location when the FOB tethers are broken.

14. The system of claim 7, wherein the smart device App is configured to alarm the captain when the participant is in the water along with their location information.

15. The system of claim 14, wherein the location information includes location of the flag, captain's console, and FOBs.

16. The system of claim 14, wherein the smart device App provides status on activation of an SOS protocol and provide information and direction.

17. The system of claim 7, further comprising a kill engine or switch that is located on the watercraft.

18. The system of claim 17, wherein the kill engine or switch is ignited to turn OFF an ignition system of the watercraft.
